(19) United States
(12) Patent Application Publication
(10) Pub. No.: US 2026/0186491 A1
(43) Pub. Date: Jul. 2, 2026

(54) SELF-DRIVING VEHICLE FOR TRANSPORTING A RECEIVING CONTAINER FOR A SLIVER, AND CAN DEVICE COMPRISING A RECEIVING CONTAINER

(71) Applicant: TRÜTZSCHLER GROUP SE, Mönchengladbach (DE)

(72) Inventor: Johannes BOSSMANN, Sonsbeck (DE)

(73) Assignee: TRÜTZSCHLER GROUP SE, Mönchengladbach (DE)

(21) Appl. No.: 18/863,992

(22) PCT Filed: May 5, 2023
(86) PCT No.: PCT/EP2023/062015

§ 371 Date: Nov. 7, 2024

(30) Foreign Application Priority Data
May 10, 2022 (DE) 10 2022 111 675.1
May 24, 2022 (EP) 22175157.1

(51) Int. Cl. G05D 1/244; B60K 7/00; B60L 53/16; G05D 1/646; G05D 107/70; G05D 111/30; G05D 111/60

(52) U.S. Cl. CPC G05D 1/2446; B60K 7/0007; B60L 53/16; G05D 1/646; B60L 2220/44; G05D 2107/70; G05D 2111/34; G05D 2111/60

(57) ABSTRACT

A self-driving vehicle for transporting a receiving container, having a container base, for a fibre sliver over an underlying surface between sliver-delivering and sliver-fed textile machines. The vehicle has an undercarriage with a plurality of wheels, a vehicle body supported by the undercarriage, a transport surface arranged on the vehicle body for mounting the receiving container, fastening elements for fastening the receiving container to the vehicle body, and an on-board electrical system arranged on the vehicle body and including an electrical energy storage, an electrical drive unit and a control unit. The vehicle is dimensioned so that in an installed state, with the receiving container mounted on the transport surface and fastened to the vehicle body, the container base entirely covers the undercarriage, the vehicle body, the electrical drive unit and the electrical energy storage means. The invention further relates to a can device including the self-driving vehicle and the receiving container.

### CROSS-REFERENCE TO RELATED APPLICATIONS

This application is a U.S. National Stage of International application PCT//EP2023/062015 filed May 5, 2023, which claims priority from German Application DE 10 2022 111 675.1, filed May 10, 2022, and European Application EP 22175157.1, filed May 24, 2022.

### BACKGROUND OF THE INVENTION

The present invention relates to a self-driving vehicle for transporting or carrying a receiving container for a fibre sliver over an underlying surface between sliver-delivering and sliver-fed textile machines, the vehicle having an undercarriage with a plurality of wheels, a vehicle body which is supported by the undercarriage and has a transport surface for the receiving container, fastening means for fastening the receiving container to the vehicle body, and an on-board electrical system having an electrical energy storage means, an electrical drive unit and a control unit, which electrical system is arranged on the vehicle body. The present invention further relates to a can device having a receiving container for a fibre sliver and a self-driving vehicle.

Customarily several hundreds of sliver cans, also known as spinning cans or simply cans, are used in a spinning room, and those cans have hitherto predominantly still been moved between the textile machines by hand. This is associated with a large amount of manpower. In order to reduce the manpower involved, attempts have already been made for decades to automate the transport of the cans.

DE 35 32 172 A1 discloses a transport system for sliver cans having transport cars which follow induction loops embedded in the spinning room floor.

CN 212685777 U discloses a self-driving vehicle, what is known as an automatic guided vehicle, abbreviated to AGV, which automatically carries and transports sliver cans. The vehicle has an adjustable tightening device which is able to adapt to different sizes of can. The can is placed on the top of the vehicle by a transfer device and fixed by the tightening device which is applied to the exterior of the can. Once the vehicle has transported the can and unloaded it again, it is ready for transporting the next can.

DE 36 21 370 A1 discloses an automatically controlled transport car, comprising a chassis having an electric motor for the travel drive and four wheels which are mounted on two steered drive axles. The transport car has a loading and unloading device for the sliver can in the form of a gripper arranged on the chassis. The gripper has two horizontal telescopic cylinders which can be extended over the transport car in order to be able to grip the can to be transported and pull it onto a transport surface of the transport car, which transport surface is provided with a roller conveyor. The gripper further comprises a pressure cylinder in order to engage around the can from the outside, the clamping members of the gripper having the same but opposite curvature in relation to the round surface of the can. During transport, the can is situated between the wheels.

CN 113668102 A discloses a further self-driving vehicle for transporting sliver cans. The vehicle has a base which is constructed on an undercarriage equipped with stepping motors. The base is equipped with a rotationally drivable can placement region on which a sliver can be set down and, if required, rotated about the can axis. The can placement region is surrounded by an annular rim of the base from which a supporting structure projects in a vertical direction, on the upper end of which a robot arm having a left and a right side arm is provided. The two side arms form a bow-shaped structure for holding and receiving the sliver can. The left and right side arms are each provided with a control circuit, and both control circuits are connected to a controller which controls the picking-up and setting-down of the sliver can by the robot arm. Furthermore, the robot arm is said to be configured with six degrees of freedom, which consists of an arm, an elbow and a hand element connected in series and which can be adjusted flexibly in order to pick up and set down the sliver can as required. It is considered disadvantageous in the case of the known systems that the sliver cans need to be in an elevated position in order to be loadable onto the transport car and unloadable again therefrom. In addition, such a transport car requires actuators and various individual components for the loading and unloading as well as for securing the can on the transport car, with the result that the production costs are increased. Although, in order to reduce the costs, automated transport cars are known which are able to transport a plurality of cans simultaneously, as shown in EP 0 877 107 B2, such transport systems are suitable only for applications in which the textile machines have a multiplicity of similar working stations, as in the case of flyers or open-end spinning machines.

US 2020/0306905 A1 discloses a further AGV in which the can to be transported is to be moved on its own rollers. For that purpose, the AGV is moved up to the can standing on the underlying surface, clamps the can in place and carries the can along with it. Accordingly, the AGV, like a human operator, runs alongside the can.

### SUMMARY OF THE INVENTION

An object of the present invention is to provide, among other things, a self-driving vehicle which can be better integrated into the ongoing operation of a spinning room and which is more cost-effective to produce. A further object of the present invention is to provide a can device which can be better integrated into the ongoing operation of a spinning room and which is more cost-effective to produce.

That and other objects are achieved in a self-driving vehicle of the kind mentioned at the beginning by the vehicle's being dimensioned in such a way that in an installed state, in which the receiving container is in contact with the transport surface and is fastened to the vehicle, the receiving container entirely covers the undercarriage, the vehicle body and the electrical drive unit.

In other words, the vehicle is dimensioned relative to the receiving container, that is to say provided with an extent perpendicular to the vertical axis of the vehicle, in such a way that the space requirement or functional surface area of the vehicle during operation is at least substantially limited to the size of the footprint or cross-sectional area of the receiving container. The footprint of the receiving container, detached from the vehicle, is understood to be that floor area of the underlying surface which is required for the receiving container in the mounted state, irrespective of whether or not the container is touching the underlying surface. Preferably, an internal space enclosed by the receiving container to be transported has an internal diameter of at least 350 millimetres and at most 1200 millimetres. The functional surface area of the vehicle is that floor area of the underlying surface which is covered by the vehicle during operation. The overall size of the vehicle is dimensioned in such a way that the vehicle is at least substantially accommodated below the receiving container when the latter is in contact with the transport surface and is fastened to, or installed on, the vehicle by means of the fastening elements (=installed state). “At least substantially” is intended to include the vehicle's being arranged virtually entirely underneath the receiving container in the installed state, with only individual components, especially from the on-board electrical system, being able to project laterally beyond the receiving container if there is a technical necessity therefor. In principle, however, it is also possible for the whole vehicle to be entirely covered by the receiving container. The undercarriage, the electrical drive unit and the transport surface are accordingly located below the receiving container in the installed state and are therefore concealed by the receiving container in a plan view from above. The vehicle is accordingly configured for transporting only a single receiving container. It is advantageous that in the installed state the vehicle is largely protected by the receiving container. The small space requirement provides the further advantage that, in the installed state, the vehicle requires the same amount of space and preferably also has the same overall height as a manually movable standard can. This has the advantage that by the use of the vehicle it is possible to provide self-driving sliver cans which can be used without structural adjustments to the textile machines already present in the spinning room. In the installed state, the vehicle, like a conventional sliver can, that is to say a manually moved sliver can, is able to access working areas of the textile machines, such as a filling station on a can changer or the like, and can accordingly also be used for performing movements in the working areas. For example, the vehicle can be rotated together with a can rotary plate of the textile machine or the vehicle, by virtue of its driven undercarriage, is itself able to rotate below a coiler plate of the textile machine.

Where spatial details, such as “top”, “bottom”, “above” and “below” are used, they are intended merely to describe the relative arrangement of the components in question. Those details relate to the vehicle when its wheels are standing on the underlying surface. The vertical axis of the vehicle is normal to the underlying surface. The underlying surface can be a factory floor in the spinning room, on which the textile machines can be situated, a fixed ramp for bridging differences in height, a floor of a can changer of the textile machine or the like. The sliver-delivering and sliver-fed textile machines can be, for example, spinning room preparation machines, such as draw frames, carding machines, combing machines, lap-winding machines and the like, and/or spinning room machines, such as rotor spinning machines, air spinning machines, flyers and the like. In accordance with one configuration, the transport surface can define a support plane. Preferably, the vehicle has no components outside the transport surface that project beyond the support plane. The transport surface preferably lies in the support plane, which can be aligned parallel to the underlying surface. In other words, the vehicle has no components, structural elements or the like which coming from below, that is to say coming from the undercarriage, extend laterally past the transport surface and upwards through the support plane, that is to say which project beyond the support plane. In that way there are no troublesome components, such as edges, mountings, bars, loading and unloading devices or the like, laterally of or outside the transport surface, with the result that the installed state can be simply established. In particular, “laterally of the transport surface” is to be understood as radially outside the transport surface in relation to the vertical axis of the vehicle. Inside the transport surface, that is to say that surface which is in contact with the receiving container in the installed state, there can be provided fastening elements which are in principle also able to project beyond the support plane, for example bolts, screws or the like.

Furthermore, the transport surface can be formed on an upper side of the vehicle body remote from the underlying surface. Moreover, the transport surface can be arranged above the wheels in the vertical direction of the vehicle. In particular, the vehicle finishes towards the top with the transport surface. The transport surface can accordingly be that surface of the vehicle on which the receiving container stands in the installed state. The transport surface of the vehicle is smaller than or at most the same size as the footprint of the receiving container. In the case of a receiving container in the form of a “round can”, the footprint can be circular and in the case of a “rectangular can” it can accordingly be rectangular. The shape of the transport surface can correspond to the shape of the footprint, but in principle some other shape is also possible and can sometimes also be preferred. The transport surface can be, for example, in the shape of a polygon having three, four, five, six, seven, eight or more than eight corners, in the shape of a star or the like, or it can also be circular, ring-shaped, rectangular or the like. In that way the weight of the vehicle can be reduced. The transport surface can be a continuous surface, that is to say a coherent surface, or can be formed from a plurality of individual surfaces spaced apart from one another.

The vehicle body can have a base plate, it being possible for an upper side of the base plate remote from the undercarriage to comprise the transport surface. In particular, the transport surface extends as far as the outer edge of the base plate and can extend over the entire upper side of the base plate. The base plate belonging to the vehicle body is accordingly likewise entirely covered by the receiving container in the installed state. The base plate is preferably a rigid plate and can be a continuously closed plate or can likewise have bores, openings, apertures or the like. In particular, the base plate is formed integrally with the vehicle body or is releasably fastened thereto. The releasable configuration enables the base plate to be exchanged for a base plate of a different size in a simple way in order to adapt the vehicle for the transport of larger or smaller receiving containers. In particular, the vehicle-side fastening elements are formed on the base plate.

In one embodiment, the fastening elements are designed to connect the vehicle fixedly to a defined receiving container. Accordingly, a change during operation is not envisaged. In other words, the receiving container remains connected to the vehicle, irrespective of whether the receiving container is full of fibre sliver or is empty. The vehicle consequently does not require a device for loading and unloading the receiving container. As a result, the vehicle requires only a small number of components and overall is cost-effective and easy to maintain. Preferably, separation is necessary only in the event of the vehicle's being defective or for maintenance purposes, in order that the receiving container can, if necessary, be equipped with a different vehicle, and vice versa. In particular, in the installed state the vehicle-side fastening elements can co-operate with container-side fastening elements. Manually releasable fastening means, such as, for example, screw connections, are especially suitable for that purpose.

In accordance with a first configuration, the fastening elements can be arranged on the vehicle body and preferably on the base plate in such a way that in the installed state they are covered by the receiving container. In that way a blind fastening can be provided. The vehicle-side fastening elements can be, for example, bores formed on the vehicle body, especially on the base plate, which co-operate with the container-side fastening elements, for example threaded bolts and nuts. The bores can be aligned parallel to the vertical axis in order that the receiving container can be mounted on the vehicle in a simple way from above and fastened to the vehicle body. The nuts can be screwed from below onto the threaded bolts protruding through the bores. The vehicle-side fastening elements can be arranged in the support plane defined by the transport surface or can be recessed further back. It is likewise possible for the vehicle-side fastening elements to be threaded bolts which project upwards from the vehicle body, especially from the base plate, beyond the transport surface. The threaded bolts can be aligned parallel to the vertical axis in order that the receiving container can be mounted on the vehicle in a simple way from above and fastened to the vehicle body. For that purpose, the receiving container can have bores in alignment with the threaded bolts in order, for example, to clamp the receiving container mounted on the transport surface against the base plate. In that way it is also possible for conventional sliver cans to be modified by subsequently providing bores for the vehicle-side fastening elements in the can base.

In accordance with a second configuration, which can be provided as an alternative to the first configuration, the vehicle-side fastening elements can project laterally from the vehicle body, i.e. can be oriented radially with respect to the vertical axis. For example, they may be integrally formed ribs, especially having a threaded portion, or bolts, especially threaded bolts, inserted after placement of the receiving container, which are able to co-operate with container-side fastening elements, for example openings formed in a side wall of the receiving container, such as round bores or elongate holes, or slots that are open towards the bottom. The receiving container can therefore be mounted on the vehicle in a simple way from above and fastened to the vehicle by means of nuts screwed onto the threaded bolts. The nuts can be screwed from the outside onto the threaded bolts protruding through the openings.

The vehicle-side fastening elements can provide centring of the receiving container on the vehicle, so that a container axis of the receiving container to be transported or carried and a vertical axis or yaw axis of the vehicle, which axis is fixed relative to the vehicle, can coincide. In particular, the yaw axis runs through a centre point or centroid of the base plate. Furthermore, the base plate has a circumferential surface running around the yaw axis, which circumferential surface is configured so as to be exposed radially towards the outside. In that way, in the installed state the base plate does not project radially beyond the receiving container, but is entirely covered by the receiving container. Accordingly, the base plate can be dimensioned in such a way that in the installed state the circumferential surface finishes flush with the side wall of the receiving container or is recessed radially with respect to the side wall of the receiving container. In the latter case the receiving container in the installed state can have been as it were put over the vehicle from above. In accordance with one configuration, the vehicle-side fastening elements comprise through-bores formed in the base plate which run parallel to the vertical axis. By means of nuts screwed onto the threaded bolts, the receiving container and the vehicle body, especially the base plate, can then be clamped against one another. In accordance with a further configuration, the vehicle-side fastening elements can be arranged on a circumferential surface of the base plate that runs around the vertical axis of the vehicle.

Furthermore, it can be provided that at least two of the wheels are in the form of fixed wheels which are aligned in the longitudinal direction of the vehicle and have rotational axes that are fixed in relation to the vehicle body. The fixed wheels are accordingly not steerable but have a fixed alignment in the longitudinal direction. Preferably, the fixed wheels are not spring-mounted on the vehicle body. The rotational axes of the two fixed wheels can lie on a notional straight line. The notional straight line divides the vehicle body in the longitudinal direction into a front portion and a rear portion which generally can be of at least approximately equal size. The yaw axis can be normal to the notional straight line. The yaw axis is the vertical axis about which the vehicle turns on the underlying surface during manoeuvring. If the yaw axis is normal to the notional straight line, it intersects the notional straight line at a right-angle. The two rotational axes can be arranged in such a way that the notional straight line lies on the diagonal of the receiving container if the receiving container has a cylindrical cross-section. The notional straight line can accordingly lie in a centre plane to which the longitudinal direction is normal. As a result, the vehicle can turn on the spot, i.e. about its yaw axis.

Furthermore, at least one of the wheels can be in the form of a support wheel which is configured so as to be pivotable about a pivot axis. In preferred manner, the at least one support wheel is freely rotatable about its pivot axis, which can be aligned parallel to the vertical axis of the vehicle. In order to reduce the risk of the vehicle's tilting, the at least one support wheel can be arranged between the two fixed wheels in the transverse direction. In particular, the at least one support wheel is supported on the front portion or the rear portion of the vehicle body spaced apart in the longitudinal direction from the transverse axes of the fixed wheels.

Preferably, in the case of the configuration having a plurality of support wheels, the support wheels are arranged spaced apart from one another in the transverse direction of the vehicle in such a way that there is formed between the wheels a free strip extending in the longitudinal direction of the vehicle, which free strip is wheel-free. That strip can be available as a function portion on which components of the on-board electrical system can be arranged. In particular, the function portion extends over the entire longitudinal extent of the base plate and/or of the vehicle body.

The wheels can especially be arranged directly on the vehicle body. Preferably, all the wheels are in contact with the underlying surface when the vehicle is travelling over the floor. In general, three-point support with three wheels, especially two fixed wheels and one support wheel, is advantageous in respect of the stability of the vehicle on the underlying surface. However, it has been found that on account of the spatial conditions and the multiplicity of cans in the spinning room it can be advantageous if the vehicle is able to turn on the spot. This is made possible by the proposed central arrangement of the fixed wheels and of the two support wheels in relation to the longitudinal direction. Preferably, the undercarriage is of four-wheeled configuration. The first support wheel can be arranged on the front portion and the second support wheel can be arranged on the rear portion. A further advantage is that the vehicle, in addition to being able to travel over flat floor surfaces, is also able to travel especially well, and without tilting, over sloping floor surfaces of ramps or the like. Advantageously, at least one of the two support wheels is spring-mounted on the vehicle body. In particular, only the trailing second support wheel, i.e. the support wheel arranged in the rear portion, is spring-mounted. This prevents the vehicle from becoming unstable when travelling over sloping surfaces, when passing over uneven underlying surfaces as well as during acceleration and deceleration.

Furthermore, it can be provided that the drive unit is in driving connection with at least one of the wheels. The at least one support wheel or the support wheels can be non-driven and freely rotatable about the respective pivot axis. Further drive concepts are likewise conceivable and possible. For example, in the case of the four-wheeled undercarriage the two fixed wheels and one of the two support wheels can be non-driven and the other support wheel, especially the leading support wheel, can be driven. In the case of the three-wheeled undercarriage, the two fixed wheels can be non-driven and the single support wheel can be driven, or vice versa. The two fixed wheels can be arranged eccentrically on the vehicle body in relation to the longitudinal direction, that is to say arranged further to the front or further to the rear. The single support wheel can correspondingly be leading or trailing, that is to say arranged in front of or behind the fixed wheels,

The drive unit can have an electric motor for each driven wheel. In particular, the electric motors can be wheel hub motors. These are distinguished by their small overall size and offer sufficient driving force and load-carrying capacity for use in the vehicle. The wheel hub motors can each be equipped with a single-stage or two-stage transmission. In particular, the respective wheel hub motor has a housing in which the motor and further optional components, such as the transmission, an output shaft including bearings, can be arranged. The wheel hub motors can be integrated in the fixed wheels. The wheel hub motors can be supported on the vehicle body. It is further of advantage that the vehicle does not require an additional transmission, with the result that the vehicle is more cost-effective and easier to maintain. Furthermore, the space saved between the fixed wheels is available as a function portion on which components of the on-board electrical system can be arranged. Instead of the advantageous configuration having two electric motors, the drive unit can also have one electric motor with a transmission for driving the fixed wheels.

The vehicle can be steered by altering the rotational speed ratio between the two electric motors and/or their directions of rotation (in the same direction, in opposite directions). In order to drive and steer the vehicle in a simple way, the drive unit can be in driving connection with the two fixed wheels. The steering movements can be specified by altering the rotational speed of the fixed wheels. Preferably, the two electric motors are each connected to a servo converter which supplies the respective electric motor with the power required for the movement. In the case of actuation in opposite directions, the vehicle is able to turn on the spot. In particular, instead of individual servo converters it is also possible to provide a double converter in the case of two driven wheels or a multiple converter in the case of three driven wheels. Instead of the servo converter it is also possible to use a frequency converter or other means for achieving the specified rotational speed, provided a rotational speed is specified and actuated for each electric motor individually.

In preferred manner, the on-board electrical system can have a reading unit which is configured for detecting guide elements arranged on the underlying surface. By means of the guide elements it is possible to specify fixed routes between the textile machines. The reading unit can be arranged on the function portion of the vehicle body, which portion is formed in the transverse direction of the vehicle between two of the wheels which are spaced apart from one another in the transverse direction, especially the two fixed wheels. This largely prevents at least some of the wheels, especially the fixed wheels, from rolling over the guide elements arranged on the underlying surface, with the result that the guide elements are protected from excessive wear. Preferably, the at least one support wheel or all of the support wheels are likewise arranged outside the function portion. The function portion as a whole is accordingly wheel-free. As a result of the reading unit's being coupled to the control unit, the vehicle has a cost-effective but adequate on-board intelligence system for automated operation, or control, of the vehicle. The information detected by the reading unit can be transmitted to the control unit in order to move the vehicle along the stationary guide elements by controlling the drive unit. The vehicle can thus follow the specified routes in a cost-effective and failsafe way, which routes can be specified between the textile machines as well as, for example, to parking areas, charging stations for charging the energy storage means, etc.

Preferably, the reading unit comprises a magnetic tape reading device which is configured for detecting, especially contactlessly detecting, the course of guide elements in the form of magnetic tapes. The vehicle can thereby be guided in a simple and cost-effective way. In principle it is also conceivable and possible for the magnetic tape reading device, which can also be referred to as a magnetic scanner, to be configured for detecting individual magnetic dots which are arranged, for example, in a grid pattern or in the form of a dotted line having a specific spacing on the underlying surface. In comparison with the induction loops known from the prior art, magnetic guide elements offer the advantage that they do not require a power source. In addition, it has been found that by means of the magnetic tapes it is also possible to guide the vehicle over a metal underlying surface, such as, for example, a ramp having metal rails. Alternatively, also conceivable in principle are optical solutions in which the reading unit has an optical scanner, but they are susceptible to contamination and are of only limited suitability for guiding the vehicle on account of the dust levels in a spinning room. Although other conventional sensors, such as infrared or ultrasonic sensors, are conceivable and possible, their implementation is sometimes too cost-intensive and complex.

The magnetic tape reading device, which can also be configured for magnetic grid points, is preferably arranged on a front end of the vehicle body in the main direction of travel over the underlying surface (forward travel). In particular, the magnetic tape reading device is arranged at an end of the front portion remote from the rear portion. The magnetic tape reading device can have a width, that is to say an extent in the transverse direction of the vehicle, that can preferably be between 50 millimetres and 200 millimetres. Accordingly, the magnetic tape reading device can have a plurality of sensors, especially arranged one next to the other in the transverse direction, with the result that the vehicle is also able precisely to follow magnetic tapes laid in a curve. A detection region of sensors of the magnetic tape reading device can be directed towards the underlying surface. The detection region of the magnetic tape reading device can widen funnel-like towards the underlying surface, so that the region detectable on the floor can be larger than the extent of the magnetic tape reading device. The spacing of the magnetic tape reading device from the underlying surface, i.e. from a wheel contact plane defined by the fixed wheels, can be between 20 millimetres and 50 millimetres. This ensures sufficient ground clearance so that the vehicle is able to travel safely and without problems over the underlying surface and enables the vehicle to be guided precisely along the magnetic tapes. The magnetic tape reading device can be provided in the form of a device having an analog output signal or in the form of a device having a digital output signal. The digital version is more economical than the analog version and it has been found that although a deviation of the magnetic tape reading device or the sensors thereof from the centre of the magnetic tape (what is known as “centre deviation”) is defined only in discrete digital steps, this is sufficient for guiding the s driving vehicle. In the case of the analog version, the output voltage would be proportional to the centre deviation.

Furthermore, the reading unit can comprise a RFID tag reading device which is configured for reading out information from guide elements in the form of RFID tags. The vehicle can thereby be guided in a simple and cost-effective way. “Radio Frequency Identification” technology-abbreviated to RFID-allows contactless transmission of data stored on the RFID tags or transponders. By means of the RFID tag reading device, which can also be referred to as a RFID reader, address information, for example, can be read out from the RFID tags and transmitted to the control unit. The RFID tag reading device can be arranged on an underside of the vehicle body in order that it is kept as close as possible above the underlying surface. Furthermore, in the longitudinal direction of the vehicle, the RFID tag reading device can be arranged at least approximately centrally between the front end and the rear end of the vehicle body and, more preferably, in the region of or around the yaw axis. The vehicle is therefore able to turn on the spot on or over the RFID tag, without the RFID tag reading device losing contact with the RFID tag.

Preferably, the reading unit comprises the magnetic tape reading device and the RFID tag reading device. For example, the RFID tags can be arranged at junctions at which a plurality of magnetic tapes cross. The control unit thereby recognises a junction in a cost-effective way. Accordingly, it can, for example, cause the vehicle to turn off or travel straight ahead at the junction. RFID tags can also be provided as waypoints between the junctions in order to recognise when defined intermediate points have been reached or crossed. It is likewise possible for RFID tags to be provided at ends of magnetic tapes in order, for example, to identify a parking area, a charging station, etc.

In an advantageous configuration, the control unit comprises a storage medium on which an application program or the like can be stored. In that way it is possible to store control commands which the vehicle performs on recognising the guide elements. Accordingly, the vehicle can, for example, travel along pre-programmed paths along the guide elements in order to transport the receiving container to be transported from a sliver-delivering textile machine to a sliver-fed textile machine, and vice versa.

Furthermore, the vehicle can have a receiving unit for receiving control commands from a higher-level master controller. The master controller can assume the vehicle control for a multiplicity of vehicles within the spinning room. Such a master controller can in principle also be coupled to the textile machines in order to be able to employ the vehicles as needed. For example, the master controller can request the vehicle to turn off, travel straight ahead or turn around at the junctions which the vehicle recognises by reading the RFID tag. Furthermore, the vehicle can have a transmitting unit for transmitting information to the higher-level master controller. The information can contain, for example, position data of the vehicle. The position data need not be real-time data. Rather, for cost-effective implementation it can be sufficient for the read-out address data to be transmitted to the master controller on passing over the RFID tags. Further information can include the speed of travel, the state of the energy storage means, departure from the metal strip, the registration of an overtemperature, errors in the individual control and drive elements, the power consumption of the electric motors as well as the torque to ascertain a loop deadlock, an established connection to charging contacts etc. For monitoring the state of the energy storage means, the on-board electrical system can comprise a battery management system, so that information relating to the charging state or the progress during charging of the energy storage means, the integrity state, the temperature of the rechargeable battery, the current discharge power, errors etc., can be available. Preferably, the vehicle comprises a radio module, especially a WLAN device, in which the receiving unit and the transmitting unit can be combined, or at least a radio antenna therefor.

Advantageously, the on-board electrical system is also covered by the receiving container in the installed state, it being possible, if technically required, for individual components also to be arranged outside the region covered by the receiving container. For example, such a component can be the radio module in order to improve the quality of the radio connection to the higher-level master controller. Furthermore, such a component can be a charging interface for charging the energy storage means, which charging interface needs to be accessible from the outside in order to facilitate automatic docking of the vehicle to an external charging station. The charging interface could, however, also be arranged in the region covered by the receiving container and especially arranged on the underside of the vehicle. In that case, for charging, the vehicle could “pass over” the connection contacts of the charging interface. It is likewise possible for inductive charging of the energy storage means to be provided. Furthermore, the on-board electrical system can have a safety device for impact detection, the individual components of which are located outside the covered region in order to detect the collision with an obstacle. For example, a contact sensor can be integrated in a bumper arranged on the receiving container or on the vehicle, which contact sensor is connected to the control unit. As a result, the control unit is able to stop the vehicle if an impact is detected and, optionally, report the triggering of the safety device to the higher-level master controller.

In order that the on-board electrical system is protected from external influences it can be arranged on an underside of the vehicle body remote from the transport surface. Furthermore, the components of the vehicle that are covered by the receiving container in the installed state can be arranged on the underside of the base plate. Moreover, an underbody panel arranged on the vehicle body can protect the on-board electrical system from below. Preferably, those components which are located outside, or project laterally beyond, the receiving container in the installed state are arranged in and/or on an electrical housing supported by the undercarriage. The charging interface can be arranged in the electrical housing so as to be accessible from the outside. Furthermore, an on/off switch can be provided on the electrical housing and is therefore accessible from the outside so that the electrical power supply of the on-board electrical system can be interrupted manually.

A further way of achieving the above-mentioned object lies in a can device having a receiving container for a fibre sliver and the above-described self-driving vehicle for transporting or carrying the receiving container over the underlying surface between sliver-delivering and sliver-fed textile machines. The can device can also be referred to as a “self-driving can”. The receiving container is in contact with the transport surface of the self-driving vehicle and is fastened to the vehicle body, the receiving container entirely covering the undercarriage, the vehicle body, the electrical drive unit and the energy storage means. The can device according to the invention brings about the same advantages as those described in connection with the vehicle according to the invention, so that here brief reference is made to the above description, it being understood that all mentioned configurations of the vehicle are transferrable to the can device and vice versa.

The can device is of modular construction and comprises the self-driving vehicle and the receiving container as modules. The modular construction enables the production costs to be reduced, because the vehicle and the receiving container can be produced separately from one another and even by different manufacturers. The vehicle is “married” to the one receiving container and remains permanently connected thereto (=installed state). Preferably, separation is necessary only in the event of the vehicle's being defective or for maintenance purposes. The purpose of such a permanent connection is that the loading and unloading of the receiving container from the vehicle, which is regarded as disadvantageous, is not required. The fastening of the receiving container to the vehicle is an installation step that is preferably carried out manually, but which can in principle also be carried out by an industrial robot.

The footprint of the receiving container can be defined by the side wall extending around the container axis in the circumferential direction. The footprint can correspond to the cross-sectional area of the receiving container. Because the space required by the vehicle is at least substantially limited to the size of the footprint of the receiving container, the can device can externally largely correspond to a conventional spinning room can having rollers attached to its underside (also referred to as a “standard can”). In preferred manner, the can device has the same dimensions as the standard can that is to be replaced. Accordingly, the can device, like a standard can, is able to enter the working areas of the textile machines, such as filling stations on a can changer or the like, and therefore can also be used for performing movements in the working areas. The change from the standard can to the self-driving can device therefore does not necessitate any adjustments to the textile machines.

The receiving container is in contact with the transport surface of the vehicle, which transport surface is at most the same size as, or is preferably smaller than, the footprint of the receiving container. Preferably, the vehicle carries the receiving container which is correspondingly spaced apart from the fixed underlying surface. The transport surface can be configured so as to run perpendicular to the vertical axis, radially with respect to the vertical axis and/or obliquely, i.e. tapered. In preferred manner, the receiving container has a fixed supporting structure which is in contact with the transport surface. The supporting structure can be internal, that is to say inside the interior space enclosed by the side wall of the receiving container, and can be recessed with respect to a lower edge of the receiving container, that is to say set back towards an upper filling opening of the receiving container. The supporting structure can comprise a fixed container base which divides the interior space of the receiving container into a filling space, which is open towards the top, for receiving the fibre sliver and an equipment space, which is open towards the bottom, in which the vehicle is installed. The receiving container can therefore have been as it were put over the vehicle from above. In the filling space there can be arranged, in a manner known per se, a plate, especially a spring-loaded plate, which is able to sink down towards the container base under the weight of the column of fibre sliver that accumulates during the coiling. In the case of the can device, the underside of the container base can be in contact, especially direct contact, with the transport surface. In particular, the receiving container can be supported on the transport surface by way of the container base. The supporting structure can also have one or more struts, supports, a rim or the like and can form a beam-like, net-like or ring-shaped supporting surface. Especially in the case where the transport surface is aligned radially with respect to the vertical axis, the receiving container can have its container base in contact with the transport surface and can be clamped against the transport surface by means of the fastening means, so that no further supporting structure is required. However, the supporting structure can comprise, for example, a ring-shaped rib in the interior of the receiving container, which rib is supported on a horizontal portion of the transport surface in order to be better able to absorb weight forces. The supporting structure accordingly need not provide dust-free separation between the filling space and the equipment space. Rather, it can be advantageous if smaller sliver oddments that collect in the filling space or other contaminants are able to drop downwards through the equipment space and fall onto the underlying surface. If the supporting structure comprises the container base, which can generally be formed as a disc, the container base can have at least one hole and, more preferably, a plurality of eccentrically located holes. The holes in the container base or openings in the supporting structure can be positioned in such a way that the contaminants fall out in the radially outer edge region of the vehicle and preferably outside the function portion and especially passing by the on-board electrical system. For example, the contaminants can be discharged in the pivot region of the support wheels. Also conceivable in principle, however, is separation of the filling space from the equipment space in as dust-free a manner as possible in order to keep the vehicle as free of fibre sliver residues as possible. Instead of the fixed container base, which is customarily used in the case of round cans, the receiving container can also have a height-adjustable filling base, which is often used in the case of rectangular cans, and can have the supporting structure. The base plate can be matched to the cross-section of the interior space of the rectangular can. If the receiving container has the shape of a “rectangular can”, a device can be provided for discharging the contaminants that fall out of the filling space, which device is arranged underneath the movable base and guides the contaminants laterally into the outer edge region, from where they can then fall onto the underlying surface.

In particular, the receiving container and the vehicle can be connected to one another by means of fastening means, the fastening means comprising the vehicle-side fastening elements and the container-side fastening elements. In accordance with a first configuration, the fastening means can be entirely covered by the receiving container. Accordingly, they are not accessible from the outside during operation of the self-driving can device, as in the case of a blind fastening, unless the can device is placed “on its head”. The container-side fastening elements can be arranged entirely in the equipment space and can project into the equipment space parallel to the container axis of the receiving container. The container-side fastening elements, for example bolts, threaded pins or the like, can be arranged, especially integrally formed, on the underside of the supporting structure. They can be inserted into the vehicle-side fastening elements, for example through-bores, and can then be secured. Preferably, nuts are provided which are screwed onto the container-side fastening elements in order to clamp the supporting structure and the vehicle body, for example the base plate thereof, against one another. Furthermore, the vehicle-side fastening elements can comprise, for example, bolts, threaded pins or the like, which project upwards from the vehicle body, especially from the base plate, beyond the transport surface and extend into or through complementary bores in the receiving container. In that way a blind fastening is likewise provided. In accordance with a second configuration, which can additionally or alternatively apply to the first configuration, the vehicle-side fastening means can project from the vehicle body radially with respect to the vertical axis. These can be, for example, ribs, bolts, threaded pins or the like, which protrude through openings in the side wall of the receiving container. The side wall and the transport surface can be clamped against one another by means of nuts. It equally applies in respect of the configurations that, in the installed state, the container axis of the receiving container can coincide with the vertical axis, or the yaw axis, of the vehicle.

In preferred manner, the vehicle is housed at least substantially in the equipment space. “At least substantially” is intended to include that firstly, as described above, individual components can project laterally beyond the receiving container and, secondly, the wheels project on the underside of the receiving container in order to ensure sufficient ground clearance. The vehicle can have an overall height of at least 50 millimetres and of at most 260 millimetres. The overall height can be determined by the spacing between the wheel contact plane and the support plane defined by the transport surface. In the installed state, the vehicle can project at least 10 millimetres and at most 40 millimetres beyond the underside of the receiving container. The equipment space can have a depth, i.e. an extent in the vertical direction, of at least 60 millimetres and at most 220 millimetres. Accordingly, the equipment space is on the one hand sufficiently deep to be able to receive the vehicle. On the other hand, the filling volume of the receiving container is only negligibly reduced. Accordingly, the height of the self-driving can device can correspond to the height of a standard can, so that the can device can be used without operational adjustments to the textile machines. Alternatively, the supporting structure, especially the container base, can also finish flush with the underside of the receiving container, as in the case of a sleeve. As a result, the receiving container can be produced more cost-effectively. Since the receiving container then does not have an equipment space, a circumferential collar can be arranged laterally on the vehicle body in order to protect the vehicle, which collar can be flush with the side wall of the receiving container in the installed state.

### BRIEF DESCRIPTION OF THE DRAWINGS

Preferred embodiments are explained below with reference to the Figures in the drawings, wherein:

FIG. 1 shows a front view of a can device in accordance with a first embodiment of the present invention situated on an underlying surface, the can device being of modular construction and having a receiving container according to the invention and a vehicle according to the invention for transporting the receiving container over the underlying surface;

FIG. 2 shows a rear view of the can device from FIG. 1;

FIG. 3 shows a simplified sectional view of the can device from FIG. 1;

FIG. 4 shows a sectional view of the receiving container from FIG. 1;

FIG. 5 shows the receiving container from FIG. 1 in a view from below;

FIG. 6 shows a plan view of the vehicle from FIG. 1, wherein, merely to illustrate the relative sizes, a base of the receiving container is indicated by a dotted line;

FIG. 7 shows the vehicle from FIG. 1 in a view from below, wherein, merely to illustrate the relative sizes, a base of the receiving container is indicated by a dotted line;

FIG. 8 shows a cross-sectional view of the vehicle from FIG. 1, wherein the vehicle is shown on the underlying surface;

FIG. 9 shows a diagrammatic view of an on-board electrical system of the vehicle from FIG. 1;

FIG. 10 shows the can device from FIG. 1 in a view from below, the can device being located on a straight route section, which is indicated by dashed lines;

FIG. 11 shows the can device from FIG. 10, the can device being located on the straight route section shortly before a curved route section;

FIG. 12 shows the can device from FIG. 11, the can device being located on the curved route section;

FIG. 13 shows the can device from FIG. 1 in a view from below, the can device being located on a straight route section shortly before a junction of the route, which is indicated by dashed lines;

FIG. 14 shows the can device from FIG. 13, the can device being located over the junction and performing a right turn;

FIG. 15 shows the can device from FIG. 14 over the junction after the 90 degree right turn;

FIG. 16 shows a cross-sectional view of a can device in accordance with a second embodiment of the present invention, wherein the can device is of modular construction and has a further receiving container according to the invention and a further vehicle according to the invention for transporting the receiving container over the underlying surface;

FIG. 17 shows a sectional view of the receiving container from FIG. 16;

FIG. 18 shows the receiving container from FIG. 16 in a view from below;

FIG. 19 shows a simplified sectional view of a can device in accordance with a third embodiment of the present invention, wherein the can device is of modular construction and has yet another receiving container according to the invention and yet another vehicle according to the invention for transporting the receiving container over the underlying surface; and

FIG. 20 shows a simplified sectional view of a can device in accordance with a fourth embodiment of the present invention.

### DETAILED DESCRIPTION

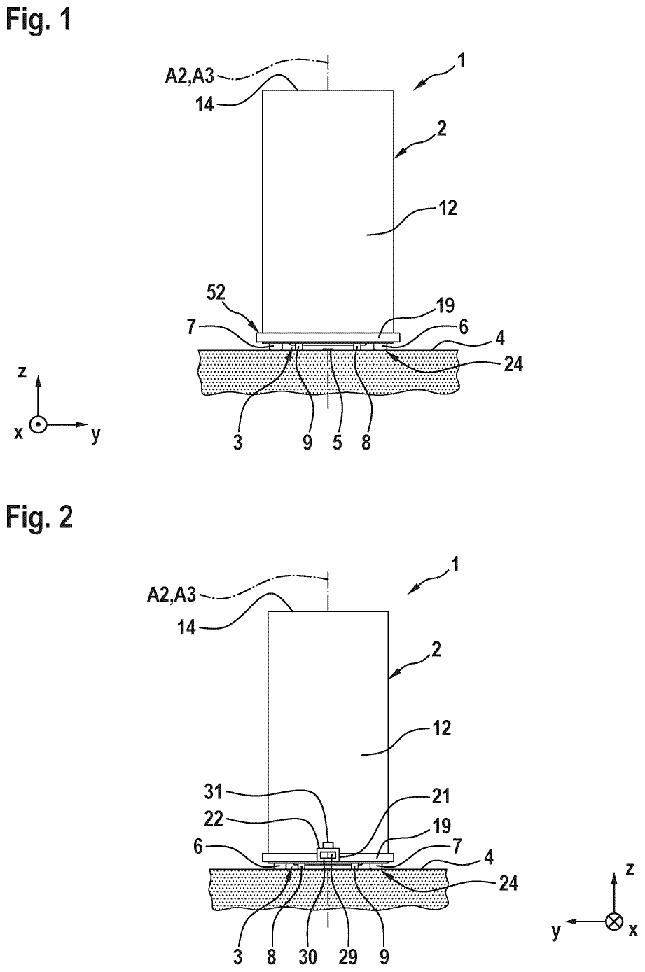

FIGS. 1 to 3 show a can device 1 in accordance with an embodiment of the present invention. The can device 1, which can also be referred to as a self-driving can, is of modular construction and has, as first module, a receiving container 2 according to the invention for a fibre sliver and, as second module, a self-driving vehicle 3 according to the invention for transporting the receiving container 2 over an underlying surface 4.

During operation, the can device 1 travels back and forth on the underlying surface 4 between textile machines (not shown) in order to transport fibre slivers from sliver-delivering textile machines to sliver-fed textile machines. For that purpose, the vehicle 3 is able to follow guide elements 5 which are arranged on the underlying surface 4 and specify routes in the spinning room. As shown in FIGS. 1 to 3, the guide elements 5 can have been applied, especially adhesively bonded, to the surface of the underlying surface 4 or can be embedded in the underlying surface 4. For example, slots and/or apertures of some other shape can be formed in the underlying surface 4, in which the guide elements 5 can be installed and then covered with epoxy resin or the like.

In order to illustrate the orientation of the can device 1 in space, FIGS. 1 to 3 show a longitudinal direction X, a transverse direction Y and a vertical direction Z which are defined in terms of a Cartesian coordinate system assigned to the can device 1 and indicated by corresponding arrows. The vertical direction Z can be normal to a floor plane defined by the underlying surface 4 when the can device 1 is standing or travelling on the underlying surface 4. Terms such as “bottom”, “below”, “top” or “above” are spatial details relating to the can device 1 situated on the underlying surface 4.

The vehicle 3 has been installed in the receiving container 2 from below, its wheels 6, 7, 8, 9 projecting on a container underside 10 of the receiving container 2. For sufficient ground clearance, a spacing S2 between the receiving container 2 and the underlying surface 4 is between 10 millimetres and 50 millimetres, with especially good results having been obtained with a spacing S2 of about 20 millimetres.

The receiving container 2 is in principle detachable but is permanently connected to the vehicle 3. That state is also referred to as the “installed state” and is shown in FIGS. 1 to 3. Specifically, fastening means 11 are provided which are not accessible from the outside unless the can device 1 is placed “on its head”. In that respect the fastening means 11 can also be referred to as internal fastening means which provide a blind fastening.

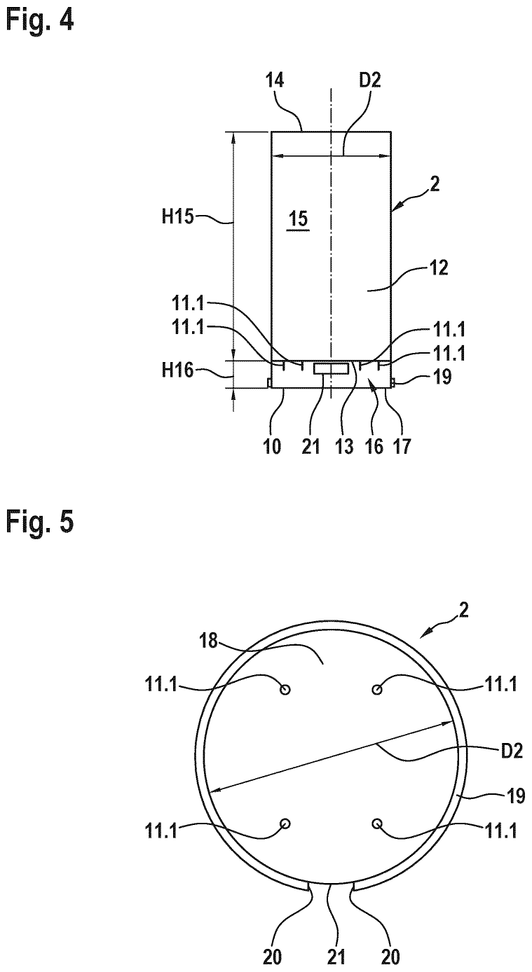

FIGS. 4 and 5 show the receiving container 2 according to the invention in detail. The receiving container has a cylindrical side wall 12 which extends concentrically around a container axis A2 that runs parallel to the vertical axis Z. An internal diameter D2 of the interior space enclosed by the side wall 12 is at least 350 millimetres and at most 1200 millimetres and is, here by way of example, 500 millimetres. Furthermore, the receiving container 2 has a supporting structure 13, which is here configured as a fixed container base in the form of a circular disc, the external diameter of which corresponds at least substantially to the internal diameter D2. The supporting structure 13, which is also referred to as the container base hereinbelow, is arranged in a recessed position and is rigidly connected to the side wall 12. “Arranged in a recessed position” means here that the container base 13 is arranged displaced away from the container underside 10 towards an upper side of the receiving container 2, which upper side is provided with a filling opening 14. The container base 13 therefore divides the interior space into a filling space 15, which is open towards the top, and an equipment space 16, which is open towards the bottom. By means of the filling opening 14, the fibre sliver can be introduced into the filling space 15 and removed again therefrom in a manner known per se. In the filling space there can be arranged, for example, a plate known per se (not shown) which can be, for example, spring-loaded and which is able to sink down towards the container base 13 under the weight of the column of fibre sliver that accumulates during the coiling. On the container underside 10 there is provided a container opening 17 which can be aligned parallel to the filling opening 14 and through which the vehicle 3 can be installed in the equipment space 16 from below. An internal diameter of the container opening 17 can correspond to the internal diameter D2 of the interior space, although in principle it can also be smaller, provided that the vehicle 3 can still be installed in the equipment space 16.

The equipment space 16 has an extent H16 in the vertical direction Z of, for example, at least 50 millimetres and at most 260 millimetres and has, here by way of example, an extent of 110 millimetres. The filling space 15 has an extent H15 in the vertical direction Z of, for example, at least 400 millimetres and at most 1500 millimetres and has, here by way of example, an extent of 1200 millimetres. Accordingly, the filling volume of the filling space 15 is, here, about 339 litres.

In the installed state, the receiving container 2 is supported by its container base 13 on the vehicle 3. For fastening the receiving container 2 to the vehicle 3, the fixing means 11 comprise container-side fastening elements 11.1, which have, for example, threaded bolts 11.1 aligned parallel to the container axis A2, onto which nuts 11.3 can be screwed. The, here by way of example four, threaded bolts 11.1 can be formed integrally with, especially welded to, a base underside 18 of the container base 13, which base underside faces towards the equipment space 16, as can be seen in the view from below according to FIG. 5.

Furthermore, a bumper 19 is arranged on the receiving container 2. The bumper is arranged in the circumferential direction around the container axis A2 on the outer side of the side wall 12. In FIG. 5 it can also be seen that the bumper 19 has a c-shaped open ring shape having two ring ends 20. A wall opening 21 is formed in the side wall 12 between the two ring ends 20, which wall opening is located on the rear side of the receiving container 2. FIG. 2 shows the rear view of the can device 1, from which it can be seen that an electrical housing 22 of the vehicle 3 extends through the wall opening 21 and projects laterally beyond the bumper 19. Alternatively, the bumper 19 can also be arranged on the vehicle 3 if the receiving container 2 is designed in the form of a sleeve where the container underside 10 of the receiving container 2 finishes flush with the container base 13. The alternative embodiment is shown in FIG. 19 and will be discussed in greater detail hereinbelow.

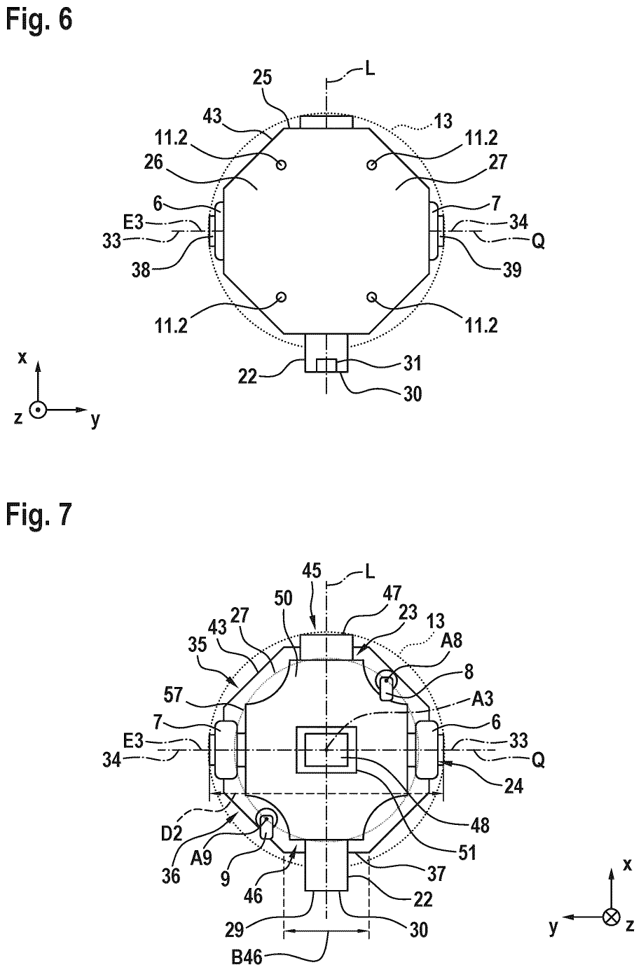

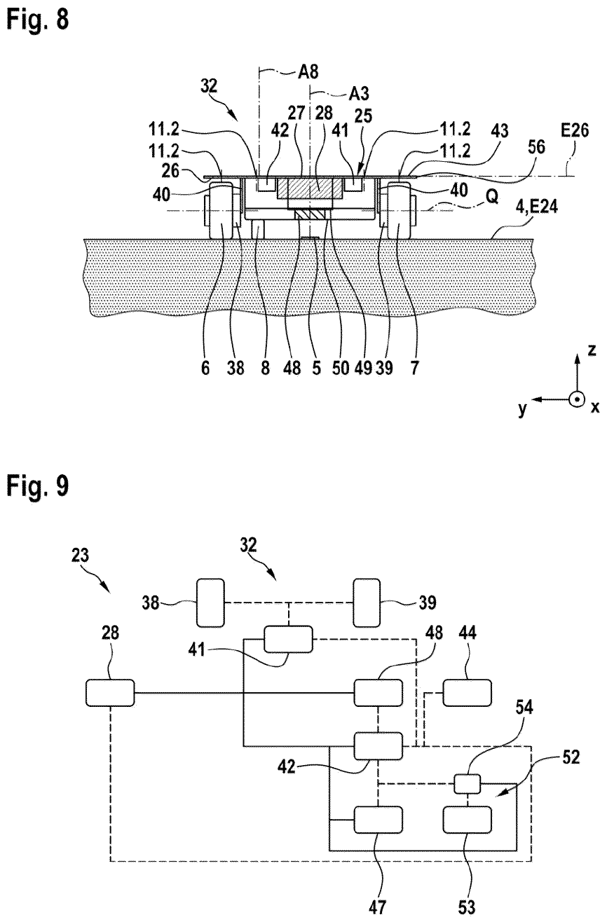

FIGS. 6 to 8 show the vehicle 3 according to the invention in detail, the circular contour of the container base 13 being indicated by dotted lines in FIGS. 6 and 7 merely in order to illustrate that, in the installed state, the vehicle 3 is substantially covered by the receiving container 2, or by the container base 13. It will be seen that only the electrical housing 22 as well as some components of an on-board electrical system 23 of the vehicle 3 that are arranged in or on the electrical housing 22 are located outside, or project beyond, the covered region.

Specifically, the vehicle 3 has an undercarriage 24 having the four wheels 6, 7, 8, 9, a vehicle body 25 supported by the undercarriage 24, a transport surface 26 with which the container base 13 of the receiving container 2 can be brought into contact, and the on-board electrical system 23 arranged on the vehicle body 25. Furthermore, the vehicle body 25 has a rigid base plate 27, the upper side of which, facing away from the undercarriage 24, comprises the transport surface 26. The base plate 27 has a circumferential surface 56 running around the yaw axis A3, which circumferential surface is configured so as to be exposed radially towards the outside and defines an outer edge 43 of the base plate 27. The transport surface 26 extends as far as the outer edge 43 of the base plate 27. The transport surface 26 lies in a support plane E26 which is parallel to the longitudinal direction X and to the transverse direction Y and to which a yaw axis A3 of the vehicle 3 is normal. The yaw axis A3 corresponds to the vertical axis of the vehicle. It is advantageous if the yaw axis A3 runs through the centre point or centre of gravity of the vehicle 3. The on-board electrical system 23 is arranged entirely underneath the support plane E26.

For fastening the receiving container 2 to the vehicle 3, the fastening means 11 further comprise vehicle-side fastening elements 11.2 which co-operate with the container-side fastening elements 11.1, i.e. they are oriented relative to one another, in such a way that in the installed state a container axis A2 of the receiving container 2 and the yaw axis A3 of the vehicle 3, which yaw axis is fixed relative to the vehicle, coincide. The vehicle-side fastening elements 11.2 can comprise through-bores which are formed in the base plate 27 and especially in the region of the transport surface 26 and into which the container-side threaded bolts 11.1 are insertable. In the installed state, the threaded bolts 11.1 are installed in the through-bores 11.2 and the nuts 11.3 are screwed onto the threaded bolts 11.1 from below in order to clamp the container base 13 and the base plate 27 against one another.

The on-board electrical system 23 is shown diagrammatically in FIG. 9. It has an electrical energy storage means 28, which is permanently installed in the vehicle 3, especially a battery, and a charging interface 29 for charging the energy storage means 28 at an external charging station. It will be understood that the energy storage means 28 can be exchanged in the event of a defect. The charging interface 29 can be arranged in the electrical housing 22 so as to be accessible from the outside. The electrical housing 22 is mounted on the vehicle body 25 and can be made from a dimensionally stable plastics material. Preferably, the electrical housing 22 has a concave end face 30. The curvature of the end face 30 is at least approximately the same as, but opposite to, the curvature of the side wall 12. This is advantageous if the can device 1 comes into contact with another can device 1 or with a standard can, because the other can will be able to rest against the curved end face 30. This may be the case, for example, in a can changer if the can device 1 is pushed against another can (“can against can” principle). Furthermore, an on/off switch 31 can be arranged on the electrical housing 22 so as to be accessible from the outside in order that the power supply between the energy storage means 28 and the other components of the on-board electrical system 23 can be interrupted manually.

Furthermore, the on-board electrical system 23 comprises an electrically operated drive unit 32, which, here by way of example, is in driving connection with the wheels 6, 7. The two wheels 6, 7 are in the form of fixed wheels which are aligned in the longitudinal direction X and are arranged spaced apart from one another in the transverse direction Y. They have rotational axes 33, 34 which are fixed in relation to the vehicle body 25 and lie on a notional straight line to which the yaw axis A3 of the undercarriage 3 is normal. It can be seen in FIGS. 6 and 7 that the notional straight line and the diagonal D2 of the container base 13 indicated by a dashed line are parallel to one another and lie in a common plane. The notional straight line divides the vehicle body 25 in the longitudinal direction X into a front portion 35 and a rear portion 36. The two portions 35, 36 can be of equal size, so that the notional straight line lies in a centre plane E3 defined by the vehicle transverse axis Y and the yaw axis A3. The vehicle body 25 can be symmetrical with respect to the centre plane E3. The electrical housing 22 is mounted on the rear portion 36 and projects beyond a rear edge 37 of the vehicle body 25.

The drive unit 32 comprises an electric motor 38, 39, especially a wheel hub motor, for each fixed wheel 6, 7. The electric motors 38, 39 in the form of wheel hub motors can be integrated in the fixed wheels 6, 7. The electric motors 38, 39 are arranged on housing struts 40 of the vehicle body 25 that project from the base plate 27, so that the fixed wheels 6, 7 remain behind the support plane E26. Furthermore, the drive unit 32 has, here by way of example, a servo converter for each electric motor 38, 39, which servo converters are here structurally combined in a double converter 41. Instead of servo converters it would also be possible to use frequency converters or other means for achieving the assigned rotational speed of the electric motors 38, 39. The double converter 41 is connected to the two electric motors 38, 39 and to the electrical energy storage means 28. By means of the double converter 41 it is possible for the two electric motors 38, 39 to be operated in the same or opposite directions and at the same or different rotational speeds to one another. The vehicle 3 can thereby be steered and, in the case of actuation in opposite directions, also turned on the spot, that is to say about the yaw axis A3. To control the electric motors 38, 39, the double converter 41 is connected to a control unit 42 of the on-board electrical system 23.

The control unit 42, which is a memory-programmable controller having a programmable storage medium, is configured for controlling the vehicle 3. Here by way of example it is in the form of a single device and is housed in a control housing. The control housing is fastened to the vehicle body 25, especially to the underside of the base plate 27. For monitoring the energy storage means 28, the on-board electrical system 23 can have a battery management system. For that purpose, the control unit 42 can be connected to the energy storage means 28. For communication with a higher-level master controller, with a textile machine or with a mobile device (smartphone, tablet, etc.), the control unit 42 can be connected to a radio module 44, which can be housed in the electrical housing 22.

Furthermore, the on-board electrical system 23 has a reading unit 45 which is configured for detecting the guide elements 5 arranged on the underlying surface. The reading unit 45 is preferably arranged exclusively on a function portion 46 of the vehicle body 25, which function portion is formed in the transverse direction Y between the two fixed wheels 6, 7. The function portion 46 has a width B46, i.e. an extent in the transverse direction Y, of at least 250 millimetres and at most 1200 millimetres and extends in the longitudinal direction X over the front portion 35 and the rear portion 36. The vehicle 3 is thus dimensioned for the transport of the receiving container 2 which, here, is configured as a “round can”. In order to be installable on a receiving container 2 in the form of a “rectangular can”, the vehicle 3 should be dimensioned correspondingly smaller. In that case the function portion 46 can also have a width of at least 150 millimetres and at most 1200 millimetres.

The reading unit 45 comprises a magnetic tape reading device 47, which is configured for contactlessly detecting the course of guide elements 5 in the form of magnetic tapes 5.1. The magnetic tape reading device 47, which can also be referred to as a magnetic scanner, is arranged at an end of the vehicle body 25 that is located at the front in the main direction of travel (forward travel), i.e. in the longitudinal direction X. The magnetic tape reading device 47 has a sensor housing in which a plurality of sensors, for example eight sensors, are arranged spaced apart from one another in the transverse direction Y. The sensor housing can have a width, i.e. an extent in the transverse direction Y, of between 50 millimetres and 200 millimetres. The spacing of the sensors from the underlying surface, i.e. from a wheel contact plane E24 defined by the wheels 6, 7, which plane coincides with the floor plane during travel over the underlying surface 4, can be between 20 millimetres and 50 millimetres. The width of the magnetic strips can be between 6 and 50 millimetres.

Furthermore, the reading unit 45 has a RFID tag reading device 48 which is configured for reading out information from guide elements 5 in the form of a RFID tag 5.2. The RFID tag reading device 48 can also be referred to as a RFID reader. The RFID tag reading device 48 is arranged below the base plate 27 on a frame 49, which is fastened to the base plate 27, in order that, during operation of the vehicle 3, the RFID tag reading device 48 is kept closely above the underlying surface 4, especially above the guide elements 5.2. The frame 49 engages around, here, the energy storage means 28, which is accordingly arranged between the base plate 27 and the RFID tag reading device 48 in the vertical direction Z. By means of the RFID tag reading device 48, address information, for example, can be read out from the RFID tags 5.2 and transmitted to the control unit 42. The RFID tags 5.2 usually have a diameter of less than 50 millimetres. To protect the on-board electrical system 23, an underbody panel 50 is arranged on the vehicle body 25 from below, which underbody panel can have an opening 51 in the region of the RFID tag reading device 48.

It can be seen in FIG. 7 that the wheels 8, 9 in the form of support wheels are arranged, i.e. supported on the vehicle body 25, eccentrically and between the two fixed wheels 6, 7 in the transverse direction Y. Their transverse spacing from the longitudinal axis L of the vehicle is, here by way of example, about 90 millimetres in each case, so that the two support wheels 8, 9 are spaced about 180 millimetres apart from one another in the transverse direction Y. The function portion 46 is formed between the support wheels 8, 9 and is accordingly free of the wheels 6, 7, 8, 9 in order to protect the guide elements 5 during operation of the can device 1. In principle, however, it is also possible for the support wheels 8, 9 to be arranged centrally, that is to say on the longitudinal axis L of the vehicle.

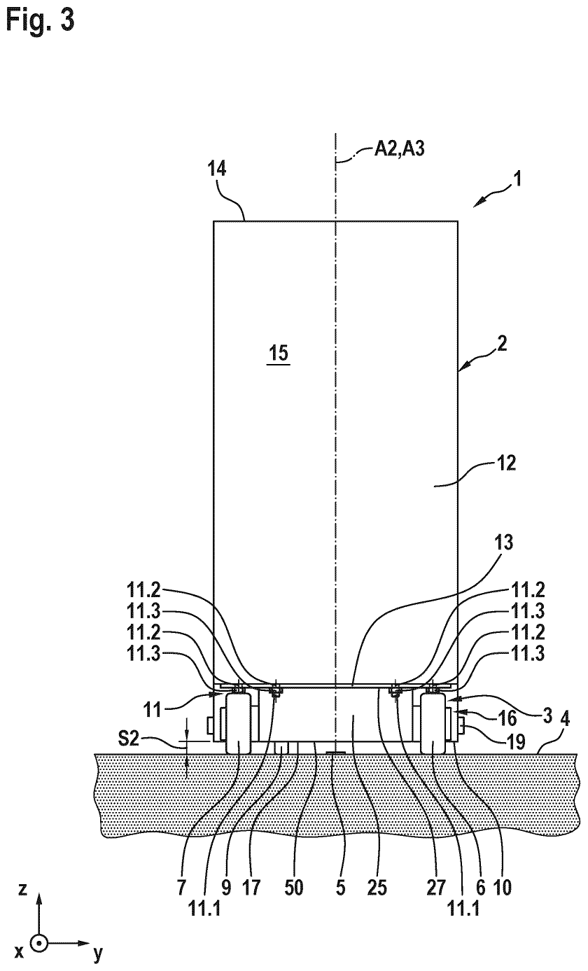

Each of the support wheels 8, 9 is mounted on the vehicle body 25 so as to be pivotable about its own pivot axis A8, A9 which is aligned parallel to the vertical axis Z. The support wheels 8, 9 can be freely pivotable about the pivot axes A8, A9, so that they are able to pivot through 360 degrees and more. Support wheel 8, which can also be referred to as the leading support wheel, is supported on the front portion 35 and support wheel 9, which can also be referred to as the trailing support wheel, is supported on the rear portion 36. The leading support wheel 8 is not spring-mounted and the trailing support wheel 9 is spring-mounted on the vehicle body 25. To improve the stability of the vehicle 3, the support wheels 8, 9 can be arranged as far as possible to the outside on the vehicle body 25 and, as shown merely by way of example by the dotted line 57 in FIG. 3, can lie on a notional circular line. In principle, however, it is also possible for the support wheels 8, 9 to be arranged at different spacings to one another from the centre plane E3 in which the two rotational axes 33, 34 lie. It is advantageous if the centre of gravity of the vehicle 3 lies in the centre plane E3 in which the transverse axis Q of the vehicle also runs.

The vehicle 3 has an overall height H3 of, here by way example, 140 millimetres. The transport surface 26 finishes the vehicle 3 towards the top. Accordingly, the overall height H3 is determined by the spacing of the transport surface 26 from the underlying surface 4, i.e. from the wheel contact plane E24.

The vehicle 3 therefore has a compact design such that, in the installed state, it at least substantially disappears below the receiving container 2, i.e. below the container base 13 thereof. Only individual components, especially from the on-board electrical system 23, are able to project laterally beyond the container base 13, because there is a technical necessity therefor. Those components can be, for example, the charging interface 29, the on/off switch 31 and the radio module 44, which are arranged in or on the electrical housing 22. In the installed state, the undercarriage 24, the electrical drive unit 32, the electrical energy storage means and the transport surface 26 are therefore entirely covered. Furthermore, as can be seen in FIGS. 1 to 8, the receiving container 2, or its container base 13, can also entirely cover the base plate 27 as well as the fastening elements 11 and can at least substantially cover the on-board electrical system 23. Of the on-board electrical system 23, in particular the control unit 42 and the reading unit 45 can be covered.

Furthermore, the on-board electrical system 23 can have a safety device 52 for impact detection. This can have components that are located outside the region covered by the receiving container 2 in order that a collision with an obstacle can be detected as early as possible. For example, a contact sensor 53 can be integrated in the bumper 19, which contact sensor is connected to the control unit 42, in order to stop the vehicle 3 if an impact is detected. The bumper 19, here, has a c-shape and the electrical housing 22 projects radially outwards between the two ring ends 20. Accordingly, the end face 30 of the electrical housing 22 can be utilised to move another can by being able to bear against the side wall thereof (“can against can” principle”) The safety device 52 can comprise a safety relay 54 in order to monitor the existence of the connection between the contact sensor 53 and the control unit 42. As a result, the contact sensor 53 can be, for example, a closing contact (normally-open contact) which is closed in the event of a collision. For that purpose, the bumper 19 can preferably be made of a flexible material, so that the normally-open contact is closed in the event of compression, especially resilient compression, of the bumper. For example, the contact sensor 53 has two wires, one of which is connected to the negative pole and the other of which is connected to the positive pole of the energy storage means 28. In principle, however, it is also possible to use a normally-closed contact instead of the cost-effective normally-open contact.

For safety reasons it can be provided that the drive unit 32 is designed to drive the vehicle 3 over the underlying surface 4 at a travel speed of at most 0.5 metre per second and more preferably of at most 0.3 metre per second. Furthermore, the drive unit 32 can be designed to provide the maximum travel speed up to a total weight of at most 200 kilograms.

It can be seen in FIGS. 6 and 7 that the surface area of the base plate 27 is smaller than that of the container base 13. The base plate 27 can have the shape of a polygon in plan view and here, merely by way of example, is in the shape of an octagon, that is to say with eight corners and eight sides. In the four corner regions that are formed with respect to the round container base 13, in which regions the container base 13 projects beyond the base plate 13, it is possible for bores (not shown) to be formed in the container base 13, through which smaller sliver oddments that collect in the filling space 15 or other contaminants can drop downwards through the equipment space 16 and fall onto the underlying surface 4. The bores are preferably formed between the respective fixed wheel 6, 7 and the function portion 14.

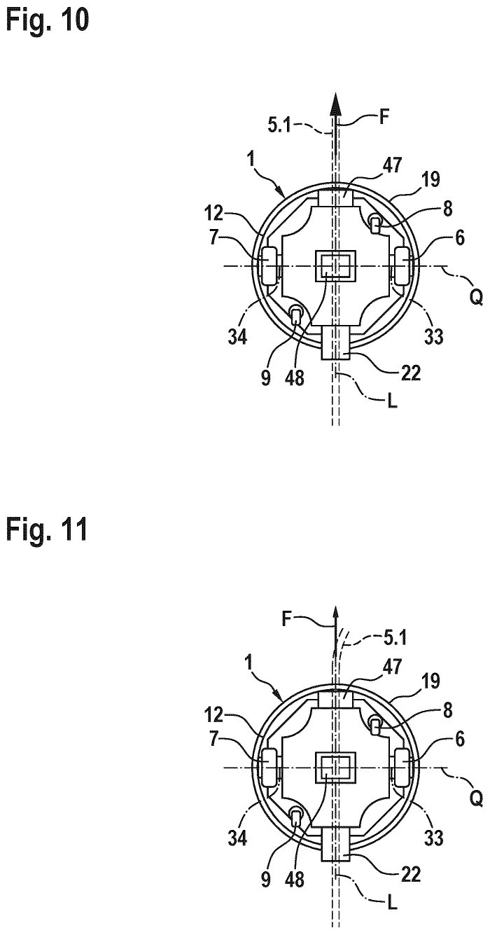

FIGS. 10 to 15 show various situations which can arise during operation of the can device 1 or the vehicle 3 during travel over the underlying surface 4 along the guide elements 5. In order to be better able to illustrate the travel behaviour of the vehicle 3, the underside of the vehicle 3 is shown seen from below through the underlying surface 4 which is shown as transparent for ease of viewing. The guide elements 5 arranged on the underlying surface 4 are indicated by dashed lines.

During travel in the main direction of travel (forward travel), which is indicated by arrow F in FIG. 10, the vehicle 3 follows the magnetic tape strip 5.1. For that purpose, the control unit 42 controls the electric motors 38, 39 on the basis of the signals received from the magnetic tape reading device 47 located at the front in the main direction of travel F in order to keep the magnetic tape strip 5.1 central between the two fixed wheels 6, 7. During travel straight ahead, the two electric motors 38, 39 are operated in the same direction and at the same rotational speed. The support wheels 8, 9 are likewise aligned in the main direction of travel F.

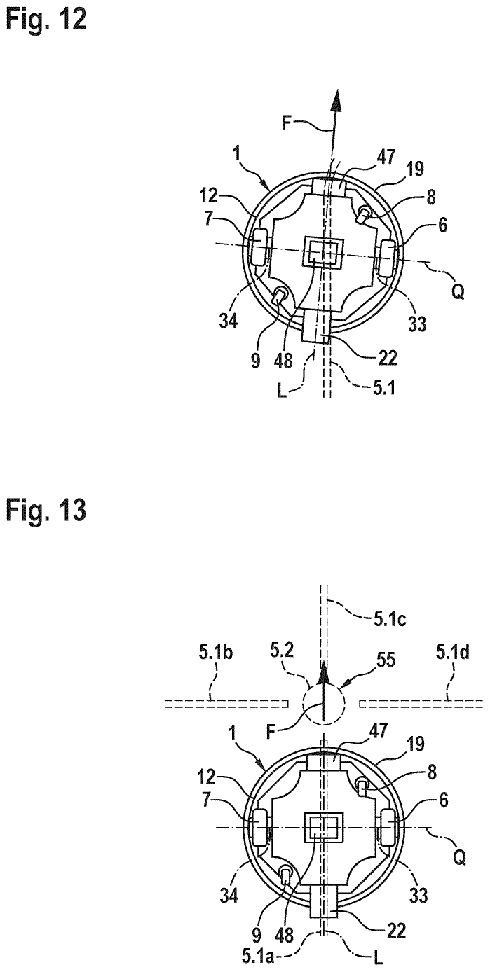

In FIG. 11, the vehicle 3 is approaching a right-hand curve specified by the magnetic tape strip 5.1, the vehicle 3 still travelling straight ahead. As soon as the magnetic tape strip 5.1 departs from the centre of the sensor field of the magnetic tape reading device 47 (centre deviation), the sensor coverage pattern changes. It can be seen in FIG. 12 that the magnetic tape strip 5.1 now moves into the detection region of the sensors of the magnetic tape reading device 47 that are arranged towards the inner side of the curve. On the basis of the sensor coverage pattern, which changes during travel, the control unit 41 is able to determine to what extent adjustments need to be made in order to keep the vehicle 3 as central as possible over the magnetic tape. This is affected by adjusting the rotational speeds of the electric motors 38, 39 relative to one another. The more the magnetic tape strip 5.1 departs from the centre, the greater must be the difference in the rotational speeds. The freely pivotable support wheels 8, 9 follow the direction of travel. The vehicle 3 is therefore steered only via changes in the rotational speeds of the electric motors 38, 39.

In FIG. 13, the vehicle 3 is approaching a junction 55 at which, here by way of example, four paths meet, those paths being specified by four magnetic tape strips 5.1a, b, c, d. In the centre of the junction 55 there is arranged a RFID tag 5.2 from which the magnetic tape strips 5.1 are spaced apart. The RFID tag 5.2 stores address information which renders the junction 55 unambiguously identifiable. The vehicle 3 will continue to travel straight ahead until the RFID tag reading device 48 detects the RFID tag 5.2. In order to prevent the control unit 42 from searching for the magnetic tape strip 5.1 by means of steering movements on account of the spacing of the magnetic tape strip 5.1a from the RFID tag 5.2, it is possible for a delay to be stored in the control unit 42, which delay is sufficiently long (for example 1-2 seconds) that the vehicle 3 continues to travel straight ahead until the RFID tag reading device 48 detects the RFID tag 5.2. The read-out RFID data are transmitted to the control unit 42, in which a fixed route can be stored. The control unit 42 can likewise also communicate with a higher-level master controller and receive up-to-date travel instructions, so that the vehicle 3 can be controlled as needed.

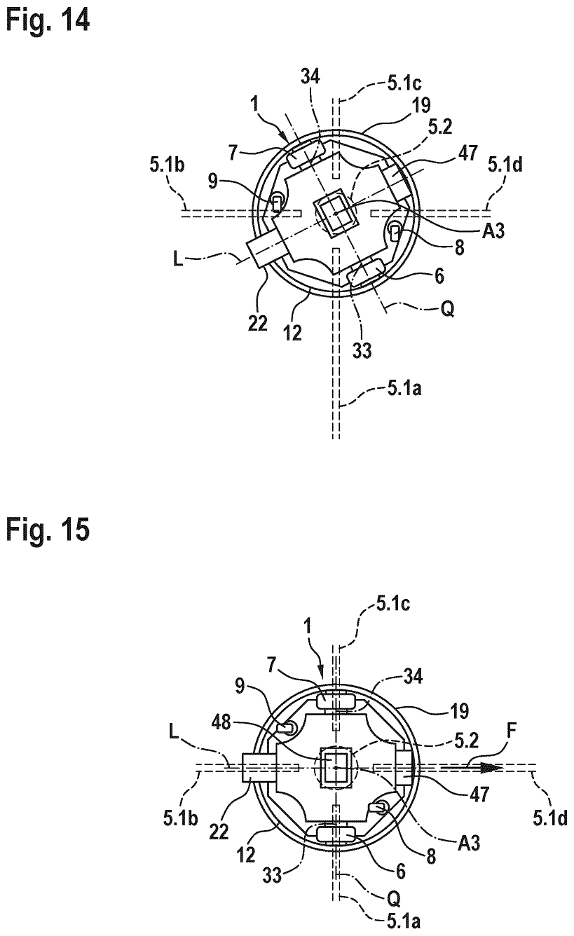

In the situation shown in FIG. 14, the control unit 42 has specified a left turn in order to turn off at junction 55. The control unit 42 turns the vehicle 3 at the junction 55 by actuating the electric motors 38, 39 in opposite directions of rotation. The left-hand electric motor 38 turns the left-hand fixed wheel 6 backwards and the right-hand electric motor 39 turns the right-hand fixed wheel 7 forwards. The vehicle 3 turns on the spot about its yaw axis A3 and therefore remains over the centre of the junction 55. During the entire turning operation, the RFID tag reading device 48 keeps the RFID tag 5.2 in the detection region, i.e. below itself.

After performing the 90 degree turn, the vehicle 3 follows the magnetic tape strip 5.1d in the main direction of travel F until it arrives at a further RFID tag. Instead of the 90 degree turn shown here, any other angle of rotation is also possible. A route can end in a textile machine, a charging station, a can magazine or the like, which can be identified by means of RFID tags.

The above-described layout of the magnetic tape strips 5.1a . . . 5.1d, which are spaced apart from one another at junction 55, has the advantage that the paths specified by the guide elements 5 can be traversed in both directions. If that is undesirable because a defined path direction, as in the case of a one-way street, is to be specified, for example in order to avoid a collision, then it is also possible to provide at junction 55 a continuous magnetic tape strip which extends without interruption over, for example, magnetic tape strips 5.1a and 5.1c. The RFID tag 5.2 can in that case be applied to the magnetic tape strip 5.1a, 5.1c.

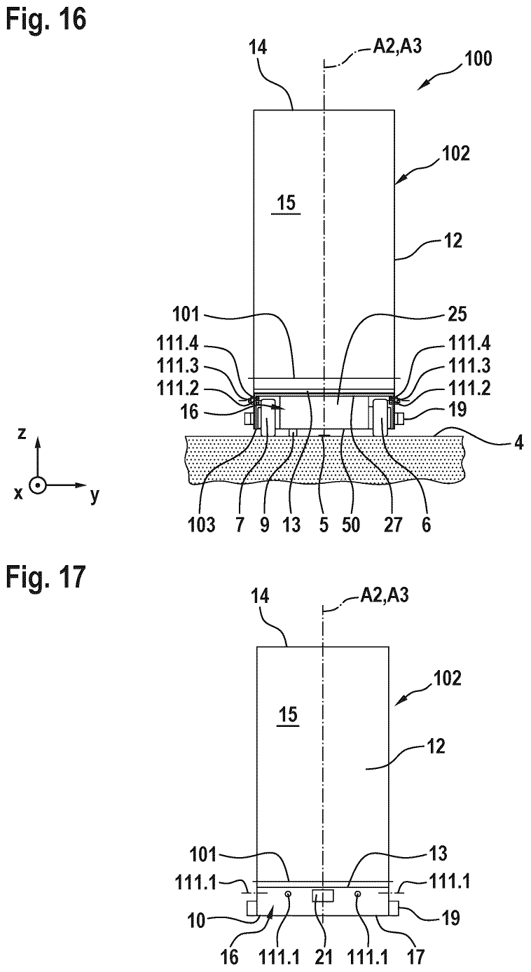

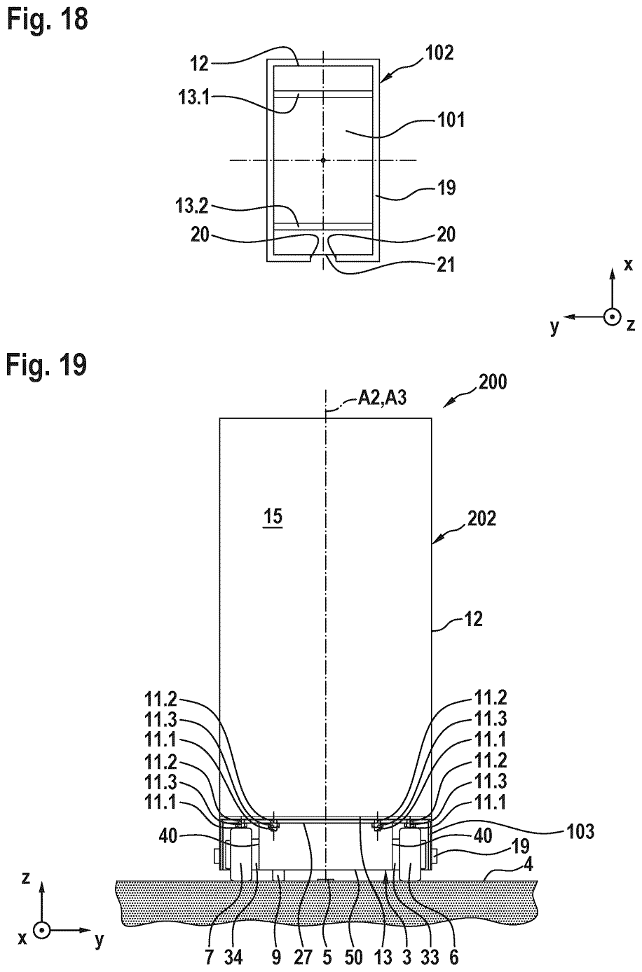

FIG. 16 shows a can device 100 in accordance with a second embodiment which largely corresponds to that of FIGS. 1 to 15, so that in respect of the common features reference is made to the description above; identical or modified details have been given the same reference signs as in FIGS. 1 to 15. The difference lies in the manner in which the receiving container 102, which, here by way of example, has a rectangular cross-section, is fastened to the vehicle 3. FIG. 16 shows the installed state. FIGS. 17 and 18 show further details relating to the receiving container 102 of the can device 100 according to the invention.

The receiving container 102, like a conventional “rectangular can”, has a filling base 101 which is guided so as to be displaceable vertically along the side wall 12, on which filling base the fibre sliver is arranged to be coiled. It can be seen in FIG. 17 that the receiving container 102 comprises container-side fastening elements 111.1 which, here on account of the bumper 19, are formed as closed bores, especially round bores, in its side wall 12. Furthermore, it can be seen in FIG. 18 that the internal supporting structure 13 of the receiving container 102 comprises, here by way of example, support struts 13.1, 13.2 which divide the interior space into the filling space 15, which is open towards the top, and the equipment space 16, which is open towards the bottom. In the installed state, the supporting structure 13 is in contact with the transport surface 26 on the upper side of the base plate 27 of the vehicle 3. In addition to the horizontal transport surface 26, the receiving container 102 is in contact with a collar 103 aligned parallel to the yaw axis A3, which collar is formed integrally with the base plate 27 and projects downwards therefrom, as shown in FIG. 16. In the collar 103 there are formed vehicle-side fastening elements 111.2 in the form of through-bores which in the installed state align with the container-side bores 111.1. For clamping the side wall 12 against the collar 103 there are provided bolts which extend through the bores 111.1, 111.2, it being possible for nuts 111.3, 111.4 to be screwed onto the bolts on both sides. Alternatively, the bolts can be screwed, for example, into the collar 103.

FIG. 19 shows a can device 200 in accordance with a third embodiment which largely corresponds to that of FIGS. 1 to 15 and that of FIGS. 16 to 18, so that in respect of the common features reference is made to the description above; identical or modified details have been given the same reference signs as in FIGS. 1 to 15 and 16 to 18. The difference lies in the configuration of the receiving container 202 which, here by way of example, has a round cross-section. FIG. 19 shows the installed state.

The receiving container 202 has a sleeve-like basic shape, wherein the container base 13 finishes flush with the underside of the receiving container 202. Accordingly, the receiving container 202 does not have an equipment space in which the vehicle 3 can be installed. Rather, the receiving container 202 is mounted in planar contact with the base plate 27 of the vehicle 3. As shown in FIG. 3 in connection with the first embodiment, the fastening means 11 are concealed by the receiving container 2. The container-side fastening elements 11.1 are, here by way of example, likewise in the form of threaded bolts which are aligned parallel to the container axis A2 and extend through vehicle-side fastening elements in the form of through-bores formed in the base plate 27 and especially in the region of the transport surface 26. On the underside of the base plate 27, nuts 11.3 are screwed onto the threaded bolts 11.1 in order to clamp the container base 13 against the base plate 27.

Furthermore, it can be seen in FIG. 19 that the bumper 19 can be arranged on the vehicle 3. For that purpose, the vehicle 3 can have a collar 103 aligned parallel to the yaw axis A3, which collar can be formed integrally with the base plate 27 and can project downwards therefrom. The bumper 19 can be fastened to the collar 103 from the outside. A contact sensor 53 for impact detection that is coupled to the control unit 42 can likewise be integrated in the bumper 19.

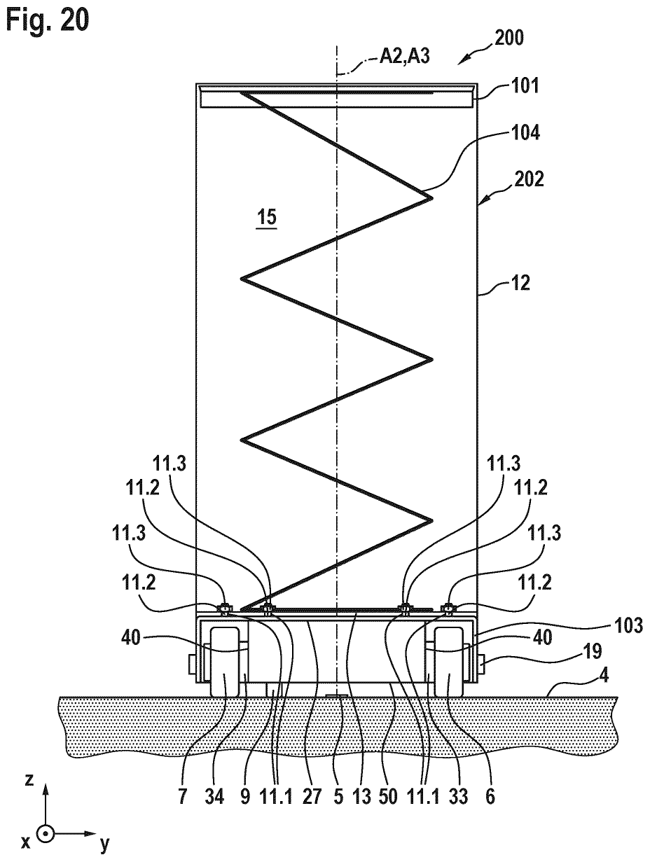

FIG. 20 shows a can device 200 in accordance with a fourth embodiment which largely corresponds to that of FIGS. 1 to 19, so that in respect of the common features reference is made to the description above; identical or modified details have been given the same reference signs as in FIGS. 1 to 15 and 16 to 18 and 19. The difference lies in the configuration of the fastening means 11.

The fastening means 11 are concealed by the receiving container 2, so that here too a blind fastening is provided. The vehicle-side fastening elements 11.2 are, here by way of example, likewise in the form of threaded bolts which are aligned parallel to the container axis A2 and extend through container-side fastening elements 11.1 in the form of through-bores formed in the supporting structure 13, here the container base. In the filling space 15 of the receiving container 202 there is arranged in a manner known per se a filling base 101, also referred to as a plate, which is displaceable along the container axis A2 and which is supported by means of a spring 104 on an upper side of the supporting structure 13. During coiling of a fibre sliver in the receiving container 2, as the column of fibre sliver accumulates the filling plate 101 sinks down towards the supporting structure 13 and tensions the spring 104. In the tensioned state of the spring 104, an installation space for the compressed spring 104 remains between the supporting structure 13 and the filling base 101, which space additionally can be utilised for the fastening of the receiving container 2 to the vehicle 3. For that purpose, nuts 11.3 can be screwed onto the projecting vehicle-side fastening means 11.1, here the threaded bolts, in order to clamp the supporting structure 13 against the base plate 27.

Reference signs

| | |
|---|---|
| 1, 100, 200 | can device |
| 2, 102, 202 | receiving container |
| 3 | vehicle |
| 4 | underlying surface |
| 5 | guide element |
| 6 | wheel, or fixed wheel |
| 7 | wheel, or fixed wheel |
| 8 | wheel, or support wheel |
| 9 | wheel, or support wheel |
| 10 | container underside |
| 11, 111 | fastening means |
| 12 | side wall |
| 13 | supporting structure |
| 14 | filling opening |
| 15 | filling space |
| 16 | equipment space |
| 17 | container opening |
| 18 | base underside |
| 19 | bumper |
| 20 | ring end |
| 21 | wall opening |
| 22 | electrical housing |
| 23 | on-board electrical system |
| 24 | undercarriage |
| 25 | vehicle body |
| 26 | transport surface |
| 27 | base plate |
| 28 | energy storage means |
| 29 | charging interface |
| 30 | end face |
| 31 | on/off switch |
| 32 | drive unit |
| 33 | rotational axis |
| 34 | rotational axis |
| 35 | front portion |
| 36 | rear portion |
| 37 | rear edge |
| 38 | electric motor |
| 39 | electric motor |
| 40 | housing strut |
| 41 | double converter |
| 42 | control unit |
| 43 | outer edge |
| 44 | radio module |
| 45 | reading unit |
| 46 | function portion |
| 47 | magnetic tape reading device |
| 48 | RFID tag reading device |
| 49 | frame |
| 50 | underbody panel |
| 51 | opening |
| 52 | safety device |
| 53 | contact sensor |
| 54 | safety relay |
| 55 | junction |
| 56 | circumferential surface |
| 57 | circular line |
| 101 | filling base |
| 103 | collar |
| 104 | spring |
| A | axis |
| B | extent in transverse direction, or width |
| D | diameter or diagonal |
| E | plane |
| F | main direction of travel |
| H | extent in vertical direction, or height |
| L | vehicle longitudinal axis |
| S | spacing |
| Q | vehicle transverse axis |
| X | longitudinal direction |
| Y | transverse direction |
| Z | vertical direction |

1. A self-driving vehicle for transporting a receiving container for a fibre sliver over an underlying surface between sliver-delivering and sliver-fed textile machines, the vehicle comprising:
an undercarriage with a plurality of wheels;
a vehicle body supported by the undercarriage and including a transport surface for the receiving container;
fastening elements for fastening the receiving container to the vehicle body; and
an on-board electrical system including an electrical energy storage means, an electrical drive unit and a control unit; wherein the electrical system is arranged on the vehicle body;
wherein the vehicle is dimensioned so that in an installed state the receiving container is in contact with the transport surface and is fastened to the vehicle body; and the receiving container entirely covers the undercarriage, the vehicle body, the electrical drive unit and the electrical energy storage device.

2. The self-driving vehicle according to claim 1, wherein the transport surface defines a support plane, and the vehicle has no components outside the transport surface that project beyond the support plane.

3. The self-driving vehicle according to claim 1, wherein the vehicle finishes towards a top with the transport surface.

4. The self-driving vehicle according to claim 1, wherein the fastening elements are arranged on the vehicle body so that in the installed state the fastening elements are covered by the receiving container.

5. The self-driving vehicle according to claim 1, wherein the vehicle body includes a base plate on which fastening elements are arranged, wherein an upper side of the base plate remote from the undercarriage comprises the transport surface.

6. The self driving vehicle according to claim 1, wherein at least two of the plurality of wheels are in a form of fixed wheels aligned in a longitudinal direction of the vehicle and have rotational axes that are fixed in relation to the vehicle body, and at least one of the plurality of wheels, is in a form of a support wheel configured to be pivotable about a pivot axis.

7. The self driving vehicle according to claim 6, wherein the rotational axes lie on a notional straight line to which a yaw axis of the vehicle is normal.

8. The self-driving vehicle according to claim 6, wherein the drive unit is in driving connection with the two fixed wheels and includes an electric motor.

9. The self-driving vehicle according to claim 1, wherein the on-board electrical system includes a reading unit arranged on a function portion of the body configured for detecting guide elements arranged on the underlying surface on the function portion of the vehicle body; and wherein the function portion is formed in a transverse direction of the undercarriage between two wheels which are spaced apart from one another in the transverse direction.

10. The self-driving vehicle according to claim 9, wherein the guide elements are in a form of a magnetic tape and RFID tags spaced aps on the magnetic tape; and the reading unit includes a magnetic tape reading device configured for detecting a course of the guide elements and a RFID tag reading device configured for reading out information from the RFID tags.

11. The self-driving vehicle according to claim 10, wherein the magnetic tape reading device is arranged at a front end of the vehicle body in a longitudinal direction of the vehicle body and the RFID tag reading device is arranged centrally between the front end of the vehicle body and a rear end of the vehicle in the longitudinal direction.

12. The self-driving vehicle according to claim 9, further comprising a charging interface for charging the energy storage means arranged on the function portion outside of or projects laterally beyond the receiving container in an installed state.

13. The self-driving vehicle according to claim 9, wherein the plurality of wheels includes at least one support wheel configured to be pivotable about a pivot axis and arranged outside the function portion.

14. The self-driving vehicle according to claim 1, wherein the on-board electrical system is arranged on an underside of the vehicle body remote from the transport surface.

15. A can device comprising a receiving container for a fibre sliver and a self-driving vehicle for transporting the receiving container over an underlying surface between a sliver-delivering and sliver-fed textile machines, wherein the self-driving vehicle is configured according to claim 1, and the receiving container is in contact with the transport surface of the vehicle and is fastened to the vehicle body, wherein the receiving container entirely covers the undercarriage, the vehicle body, the electrical drive unit and the electrical energy storage means.

16. The can device according to claim 15, wherein the receiving container includes a recessed supporting structure in contact with the transport surface, wherein the supporting structure divides an interior space of the receiving container into a filling space, which is open towards a top of the receiving container, for receiving the fibre sliver; and an equipment space which is open towards a bottom of the vehicle.

17. The can device according to claim 15, further including at least one fastening means to clamp together the receiving container and the vehicle, wherein the fastening means are entirely covered by the receiving container.

18. The can device according to claim 15, further including at least one fastening means to clamp together the receiving container and the vehicle by side fastening elements formed in a side wall of the receiving container that defines the filling space and that project outwards beyond the receiving container.

19. The self-driving device of claim 8, wherein the electric motor comprises a wheel hub motor.
